(19) United States
(12) Patent Application Publication
(10) Pub. No.: US 2022/0350430 A1
(43) Pub. Date: Nov. 3, 2022

(54) Touchpad Stack with an Antenna Layer

(71) Applicant: Cirque Corporation, Sandy, UT (US)

(72) Inventors: Jon Bertrand, Taylorsville, UT (US); Brian Monson, Farmington, UT (US)

(73) Assignee: Cirque Corporation, Sandy, UT (US)

(21) Appl. No.: 17/844,847

(22) Filed: Jun. 21, 2022

Related U.S. Application Data
(63) Continuation-in-part of application No. 17/665,699, filed on Feb. 7, 2022.
Application No. 17/665,699 is a continuation of application No. 16/713,677, filed on Dec. 13, 2019, now Pat. No. 11,281,340.

(51) Int. Cl. G06F 3/044; H01Q 1/22; H01Q 1/42

(52) U.S. Cl. CPC G06F 3/044; H01Q 1/2266; H01Q 1/421; H01Q 1/2291

(57) ABSTRACT

An apparatus includes a stack of layers where the stack has a touch sensor in at least one sensor layer of the stack of layers, the touch sensor having a first set of electrodes and a second set of electrodes, where the first set and the second set are electrically isolated from one another; an antenna in art antenna layer of the stack of layers; and a shield located between the at least one sensor layer and the antenna layer.

### CROSS REFERENCE TO RELATED APPLICATIONS

The present application is Continuation-in-Part of U.S. patent application Ser. No. 17/665,699 by Jon Bertrand et al., entitled Shield for a Capacitive Touch System. U.S. patent application Ser. No. 17/665,699 is a Continuation of U.S. patent application Ser. No. 16/713,677 by Jon Bertrand et al., entitled “Radio Frequency Transparent Capacitive Touch Systems and Methods,” filed on Dec. 13, 2019. U.S. patent application Ser. No. 16/713,677 claims priority to U.S. Provisional Patent Application No. 62/794,392 by Jon Bertrand et al., entitled “Radio Frequency Transparent Capacitive Touch Systems and Methods,” filed on Jan. 18, 2019, assigned to the assignee hereof, and expressly incorporated by reference herein.

### FIELD OF THE DISCLOSURE

This disclosure relates generally to capacitive sensors, such as a touch pad, and methods of operation. More particularly, this disclosure relates to systems and methods for enabling radio frequencies to transmit and receive through the touch pad.

### BACKGROUND

Touch pads are often included on processor-based devices, such as laptop computers or the like, in order to allow a user to use fingers, styli, or the like as a source of input and selection. Additionally, processor-based devices often include radio frequency (e.g., 3 MHz-30 GHz) transmitters, receivers, transceivers, or the like (collectively, “transceivers” herein) for Wi-Fi, Bluetooth, near field communications (NFC), or the like. However, capacitive touch pads often require electrical shielding to prevent noise from the processor-based device from interfering with normal touch pad functions. When in proximity to the radio transceiver that shielding may prevent transmission and reception of the radio frequencies.

For example, a touch pad might be the only opening in the chassis of a processor-based device (such as a laptop) and that single opening may be used for multiple purposes, such as sending and receiving Wi-Fi or NFC communications. Existing devices may place the radio frequency antenna near (e.g., underneath) the touch pad and hatch the touch pad ground plane shielding to allow some of the radio frequencies through the shielding. However, this approach often requires tuning the antenna to transmit through the shielding and tuning is often difficult. Further, the antenna system will likely waste more power than a typical installation and the performance of the touch pad may be still affected. Additionally, the above-described system may be more difficult to manufacture due to variations in the touch pad printed circuit board (PCB) affecting the antenna resonance. Other drawbacks, inconveniences, and issues with existing devices and methods also exist.

### SUMMARY

An apparatus includes a stack of layers where the stack has a touch sensor in at least one sensor layer of the stack of layers, the touch sensor having a first set of electrodes and a second set of electrodes, where the first set and the second set are electrically isolated from one another; an antenna in an antenna layer of the stack of layers; and a shield located between the at least one sensor layer and the antenna layer.

The shield may include at least one radio frequency transparent section.

The at least one radio frequency transparent section may allow radio frequency transmission to pass through the shield and the touch sensor.

The at least one radio frequency transparent section may overlap with the antenna.

The antenna layer may be combined with a component layer.

The apparatus may include a component layer between the antenna layer and the shield.

The antenna may be constructed to be compatible to transmit a signal according to a Wi-Fi protocol.

The antenna may be constructed to be compatible to transmit a signal according to a short-range wireless protocol.

The antenna may be constructed to be compatible to transmit a signal according to a Near Field Communication (NFC) protocol.

The first set of electrodes may be formed on a first stack of layers and the second set of electrodes is formed on a second stack of layers.

The first set of electrodes and the second set of electrodes may be formed on the same layer.

The stack of layers may include a pixel layer adjacent to the at least one sensor layer.

The first set and second set of electrodes may form at least one intersection, and the at least one radio frequency transparent section is offset from the at least one intersection.

The first set and second set of electrodes may form at least one intersection and the at least one radio frequency transparent section overlaps an anti-node formed by the first set of electrodes and the second set of electrodes.

An apparatus may include a stack of layers where the stack includes a touch sensor layer of the stack of layers, an antenna layer of the stack of layers, and a shield layer located between the touch sensor layer and the antenna layer.

The touch sensor layer may be a mutual capacitance sensor.

The touch sensor layer may be a self-capacitance sensor.

The shield may include at least one radio frequency transparent section.

The antenna layer may be combined with a component layer.

An apparatus may include a shield layer having a first side and a second side where the second side is opposite the first side, the first side being adjacent to a touch sensor; the second side being adjacent to an antenna layer; at least one radio frequency transparent section defined in the shield to minimize electrical interference to the touch sensor based at least, in part, on the location of an electrode in the touch sensor; and the at least one radio frequency transparent section to permit radio frequency to pass through the touch sensor based at least, in part, on a location and shape of an antenna formed on the antenna layer.

### BRIEF DESCRIPTION OF THE DRAWINGS

FIG. 1 depicts an example of a capacitive touchpad system.

FIG. 2 depicts an example of a processor-based device including a touchpad and a radio frequency transmitter in accordance with disclosed embodiments.

FIG. 3 depicts an example of a touchpad shield in accordance with disclosed embodiments.

FIG. 4 depicts an example of a touchpad shield in accordance with disclosed embodiments.

FIG. 5 depicts an example of a touchpad shield in accordance with disclosed embodiments.

FIG. 6 depicts an example of a shield structure in accordance with disclosed embodiments.

FIG. 7 depicts an example of a shield structure in accordance with disclosed embodiments.

FIG. 8 depicts an example of a shield structure in accordance with disclosed embodiments.

FIG. 9 depicts an example of a shield structure in accordance with disclosed embodiments.

FIG. 10 depicts an example of a shield structure in accordance with disclosed embodiments.

FIG. 11 depicts an example of a shield structure in accordance with disclosed embodiments.

FIG. 12 depicts an example of a shield structure in accordance with disclosed embodiments.

FIG. 13 depicts an example of a shield structure in accordance with disclosed embodiments.

FIG. 14 depicts an example of a shield structure in accordance with disclosed embodiments.

FIG. 15 depicts an example of a shield structure in accordance with disclosed embodiments.

FIG. 16 depicts an example of a shield structure in accordance with disclosed embodiments.

FIG. 17 depicts an example of a method for transmitting a wireless signal in accordance with disclosed embodiments.

FIG. 18 depicts an example of a stack of layers in accordance with the present disclosure.

FIG. 19 depicts an example of a stack of layers in accordance with the present disclosure.

FIG. 20 depicts an example of a stack of layers in accordance with the present disclosure.

FIG. 21a depicts an example of a shield layer and an antenna layer in accordance with the present disclosure.

FIG. 21b depicts an example of a shield layer and a sensor layer in accordance with the present disclosure.

FIG. 21c depicts a detailed example of a sensor layer superimposed over a shield layer in accordance with the present disclosure.

FIG. 22a depicts an example of a shield layer and an antenna layer in accordance with the present disclosure.

FIG. 22b depicts an example of a shield layer and a sensor layer in accordance with the present disclosure.

FIG. 23a depicts an example of a shield layer and an antenna layer in accordance with the present disclosure.

FIG. 23b depicts an example of a shield layer and a sensor layer in accordance with the present disclosure.

FIG. 24a depicts an example of a shield layer and an antenna layer in accordance with the present disclosure.

FIG. 24b depicts an example of a shield layer and a sensor layer in accordance with the present disclosure.

FIG. 24c depicts a detailed example of a sensor layer superimposed over a shield layer in accordance with the present disclosure.

FIG. 25 depicts an example of an antenna layer in accordance with the present disclosure.

FIG. 26 depicts an example of an antenna layer in accordance with the present disclosure.

FIG. 27 depicts an example of an antenna layer in accordance with the present disclosure.

FIG. 28 depicts an example of an antenna layer in accordance with the present disclosure.

FIG. 29 depicts an example of an antenna layer with two antennas in accordance with the present disclosure.

FIG. 30 depicts an example of an antenna layer with three antennas in accordance with the present disclosure.

FIG. 31 depicts an example of a shield layer in accordance with the present disclosure.

FIG. 32 depicts an example of a shield layer in accordance with the present disclosure.

FIG. 33 depicts an example of a shield layer in accordance with the present disclosure.

FIG. 34 depicts an example of a shield layer with two radio transparent sections of different designs in accordance with the present disclosure.

FIG. 35 depicts an example of a shield layer with three radio transparent sections of different designs in accordance with the present disclosure.

FIG. 36 depicts an example of a stack of layers in accordance with the present disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

This description provides examples, and is not intended to limit the scope, applicability, or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object's length.

For purposes of this disclosure, the term “electrode” generally refers to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, and the term “Rx” generally refers to a sense line.

It should be understood that use of the terms “touch pad” and “touch sensor” throughout this document may be used interchangeably with “capacitive touch sensor,” “capacitive sensor,” “capacitive touch and proximity sensor,” “proximity sensor,” “touch and proximity sensor,” “touch panel,” “touchpad,” and “touch screen.”

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

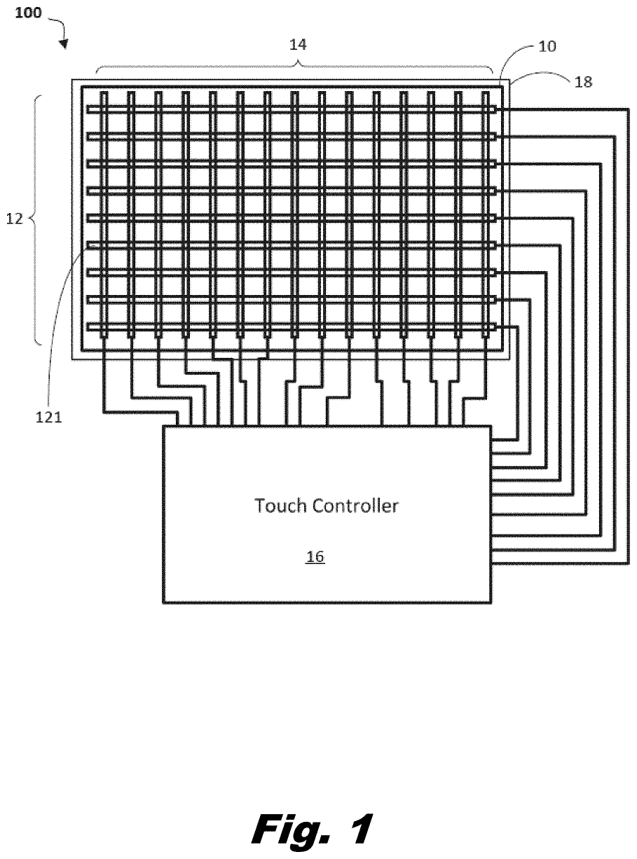

The present invention utilizes touchpad technology from CIRQUE® Corporation. Accordingly, it is useful to understand operation of the touchpad technology to a degree. The touchpad technology from CIRQUE® Corporation is a mutual capacitance sensing device 100 and an example is illustrated in FIG. 1. For this device 100 a touchpad 10 having a grid of row 12 and column 14 electrodes is used to define the touch-sensitive area of the touchpad 10. Typically, the touchpad is configured as a rectangular grid of an appropriate number of electrodes (e.g., 8-by-6, 16-by-12, 9-by-15, or the like).

As shown in FIG. 1, the mutual capacitance sensing device 100 also includes a touch controller 16. Touch controller 16 typically includes at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

Typically, touch controller 16 also includes at least one multiplexing circuit to alternate which of the row 12 or column 14 electrodes are operating as a drive electrode or a sense electrode. The driving electrodes can be driven one at a time in sequence, or randomly, or all at the same time in encoded patterns. Other configurations are possible such as self-capacitance mode where the electrodes are driven and sensed simultaneously. Electrodes may also be arranged in non-rectangular arrays, such as radial patterns, linear strings, or the like. As also indicated in FIG. 1, a ground plane shield 18 may be provided beneath the electrodes 12, 14, to reduce noise or other interference. Shield 18 is shown as extending beyond electrodes 12, 14 merely for ease of illustration. Other configurations are also possible.

Typically, no fixed reference point is used for measurements. Touch controller 16 generates signals that are sent directly to the row 12 and column 14 electrodes in various patterns.

The touchpad 10 does not depend upon an absolute capacitive measurement to determine the location of a finger (or stylus, pointer, or other object) on the touchpad 10 surface. The touchpad 10 measures an imbalance in electrical charge to the electrode functioning as a sense electrode (exemplarily illustrated as row electrode 121 in FIG. 1, but can be any of the row 12, column 14, or other dedicated-sense electrodes). When no pointing object is on or near the touchpad 10, the touch controller 16 is in a balanced state, and there is no signal on the sense electrode (e.g., electrode 121). When a finger or other pointing object creates imbalance because of capacitive coupling, a change in capacitance occurs on the plurality of electrodes 12, 14 that includes the touchpad electrode grid. What is measured is the change in capacitance, and not the absolute capacitance value on the electrodes 12, 14.

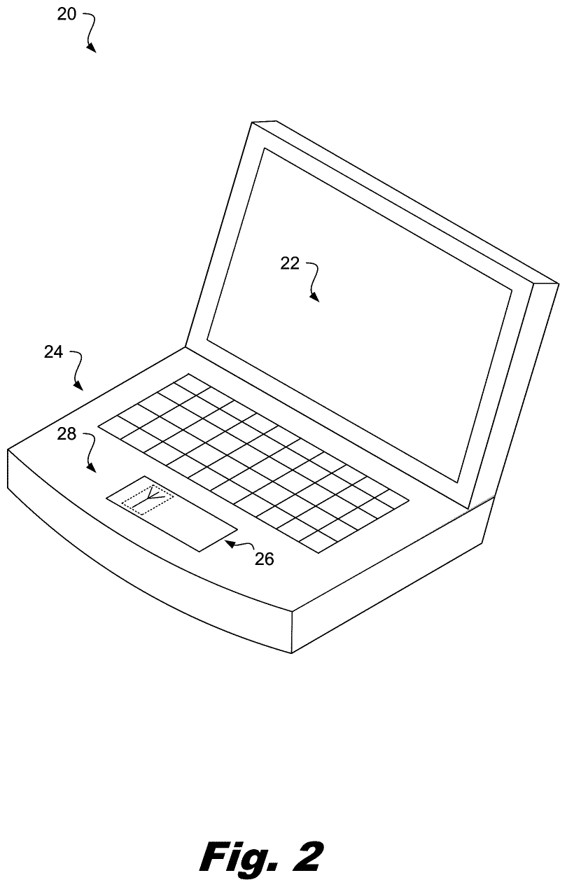

FIG. 2 is a schematic top-down view of a processor-based device including a touchpad 26 and a radio frequency transmitter 28 in accordance with disclosed embodiments. As shown for this embodiment, processor-based device may be a laptop 20 with a display 22, a keyboard 24, and a touchpad 26.

As also indicated, the laptop 20 may also include a radio frequency transceiver 28. In the embodiment of FIG. 2, the transceiver 28 is shown in dashed line to indicate that it is beneath touchpad 26, however, the location is merely exemplary and other locations may be used. Additionally, more than one transceiver 28 may be used or separate transmitters and receivers may be used.

Likewise, as a person of ordinary skill in the art having the benefit of this disclosure would understand, the type of transceiver 28 will vary with the function of the device. For example, for NFC applications transceiver 28 may operate in the 13.5 MHz frequency range, for Bluetooth applications transceiver 28 may operate in the 2.4-2.5 GHz range, and for Wi-Fi applications transceiver 28 may operate in the 2.4 GHz, 5 GHz, or other frequency range. Other applications and frequency ranges are also possible.

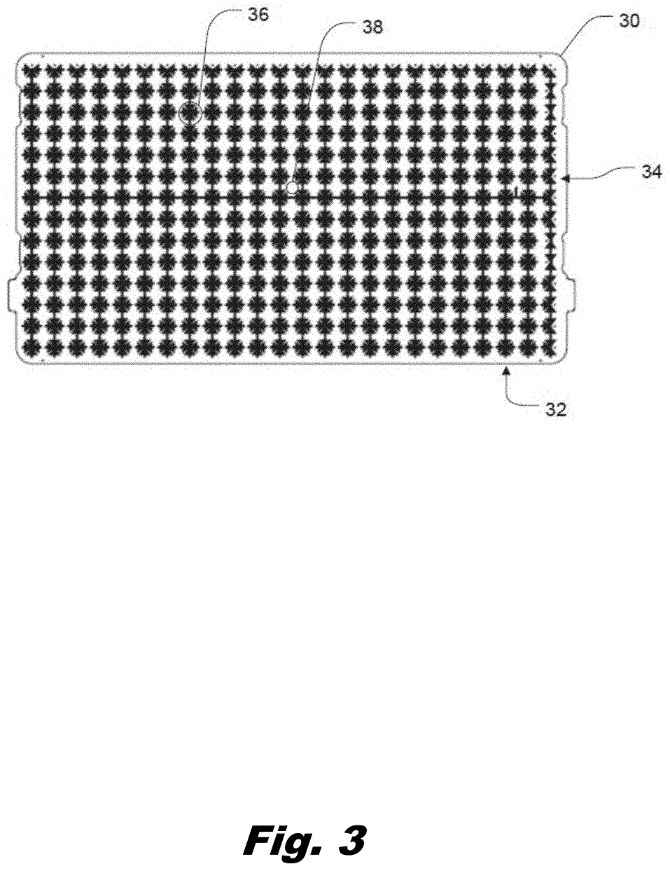

FIG. 3 is a schematic top-down illustration of a touchpad shield 30 in accordance with disclosed embodiments. As disclosed herein, a solid or hatched ground plane shield (e.g., ground plane shield 18) may interfere with the higher radio frequencies typically employed by transceiver 28 or the like, however, it needs to shield the touchpad 28 from noise and other interference so that touchpad 28 may function properly. Thus, touchpad shield 30 is designed to have a high impedance at higher frequencies (e.g., 13.5 MHz for NFC, 900 MHz, 2.4 GHz, 5 GHz, etc., for Wi-Fi) and low impedance at the touchpad 28 operating frequencies (e.g., 100 kHz to 3 MHz).

In some cases, a touchpad shield 30 may be constructed to replace a typical solid or hatched ground plane shield 18 with another layer that is a projection or combination of the touch sensor electrode layers (e.g., electrodes 12 and 14). In other examples, the touchpad shield may have a shape constructed to shield the junction areas while not shielding the areas far from the junctions. In the illustrated example of FIG. 3, a number of vertical rows 32 of shield material and horizontal rows 34 may be fashioned to lay under the corresponding electrode 12, 14 layers. The shield material may comprise copper, aluminum, or other appropriate shielding material and may be etched, printed, or otherwise deposited on a substrate. As shown, the touchpad shield 30 specifically shields the mutual capacitance junctions (e.g., junction 36) where the electrodes (e.g., electrodes 12, 14) overlap, but leaves the center (e.g., center 38) of each sensor cell open to allow radio frequencies to pass through. Additionally, the patterned shielding is divided into individual cells that shield individual sensor junctions. In some embodiments, the shielding cells may be connected to reduce and/or minimize the induced current from an NFC antenna or the like and reduce the power of the NFC system. In some cases, the cells may be connected radially, vertically, connected in other arrangements to reduce the induced currents. The particular shapes and rectangular grid shown for touchpad shield 30 in FIG. 3 are merely exemplary and other shapes and patterns may be used.

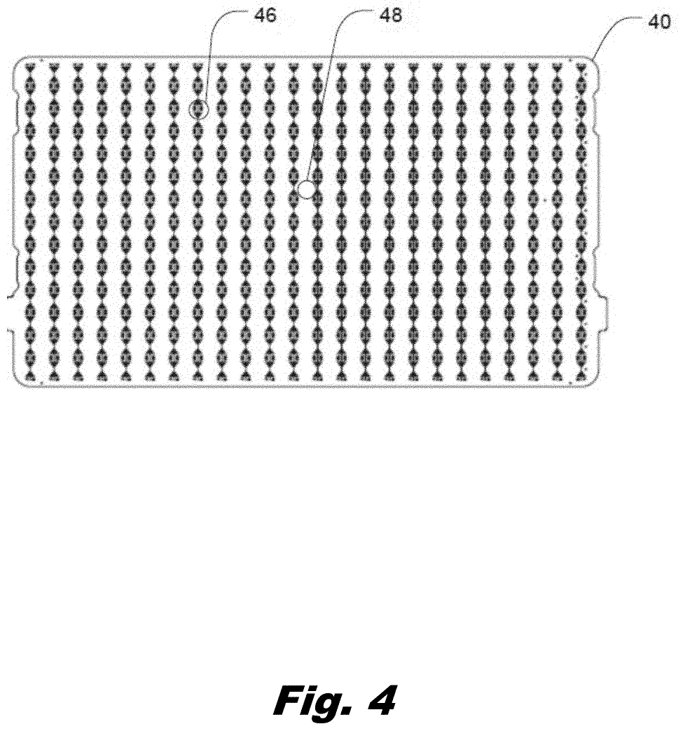

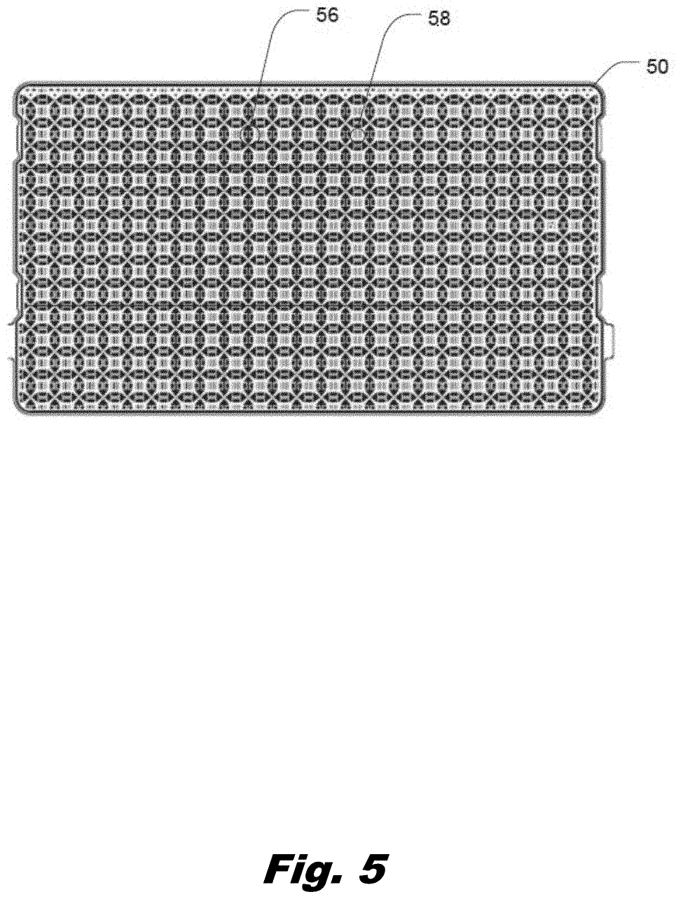

For example, FIGS. 4-5 show other exemplary shapes and patterns that may be used in accordance with disclosed embodiments. FIG. 4 shows an embodiment of a touchpad shield 40 that has relatively smaller junctions 46 and relatively larger open centers 48 and FIG. 5 shows an embodiment of a touchpad shield 50 that has relatively denser junctions 56 and relatively smaller open centers 58. As a person of ordinary skill in the art having the benefit of this disclosure would understand, other shapes, patterns, junctions, open centers, and the like may be employed depending upon the functions and frequencies involved in a particular processor-based device, touchpad, transceiver, and the like.

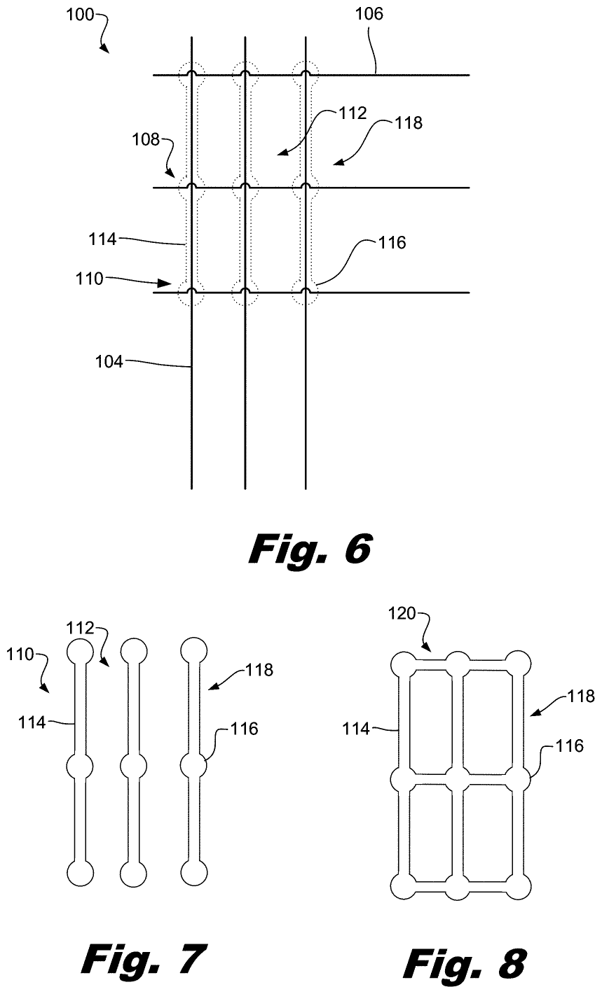

FIG. 6 depicts an example of a grid 100 of electrodes of the touch sensor 102. In this example, multiple transmit electrodes 104 are disposed on a substrate and orthogonally arranged with sense electrodes 106 also disposed on the substrate. The transmit electrodes 104 and the sense electrodes 106 overlap with each other, but are electrically isolated from each other, forming mutual capacitance intersections 108. In some cases, the electrical insulation is provided through the substrate, with the transmit electrodes 104 being disposed on a first side of the substrate and the sense electrodes 106 being disposed on a second side of the substrate. In some cases, as the voltage changes on a first transmit electrode, the capacitance on each sense electrode crossed by the first transmit electrode changes at the intersection where the electrodes cross. Further, when an electrically conductive object approaches the touch sensor, the mutual capacitance intersections near the object touching or approaching the touch sensor have changes in their capacitance at these intersections.

In some examples, the surface of the touch sensor that is configured to receive touch or proximity signals from a user is on a front, interfacing surface. The surface of the touch sensor that includes the shield near or on the opposite side or back side of the touch sensor. The shield structure may be disposed between the back surface of the touch sensor and the antenna.

In the example of FIG. 6, the shield structure includes an electrically conductive layer 110 that defines openings 112. The wireless signals transmitted by the antenna can pass through the openings 112 defined in the electrically conductive layer 110. However, the portions of the electrically conductive layer 110 that remain may overlap with the transmit electrodes 104, the sense electrodes 106, the mutual capacitance intersections 108 between the transmit and sense electrodes, other portions of the touch sensor, or combinations thereof.

In the illustrated example, the electrically conductive layer 110 includes narrow cross-sectional width 114 that is aligned with the transmit electrodes 104. At those regions of the shield structure that overlap with the mutual capacitance intersections 108, the electrically conductive layer 110 includes in width and area forming a patterned shielding area 116 to provide more efficient shielding at the mutual capacitance intersections. In this example, the patterned shielding areas 116 are electrically connected in a vertical column 118 by the narrow cross-sectional widths 114.

FIG. 7 depicts an example of an electrically conductive layer 110 with narrow cross-sectional widths 114 and patterned shielding areas 116 overlapping at the mutually capacitive intersections. The openings 112 are defined by the space between the vertical columns 118. In this specific example, portions of the sensor electrodes are not shielded by a portion of the electrically conductive layer 110.

In the example of FIG. 8, the patterned shielding areas 116 are radially connected with additional narrow cross-sectional widths 114 that overlap the sense electrodes forming a horizontal row 120. In this example, the openings are located between the vertical columns 118 and the horizontal rows 120. In some examples, radially connecting the vertical columns may minimize the induced current and/or reduce the needed power to transmit a wireless signal for some types of antennas.

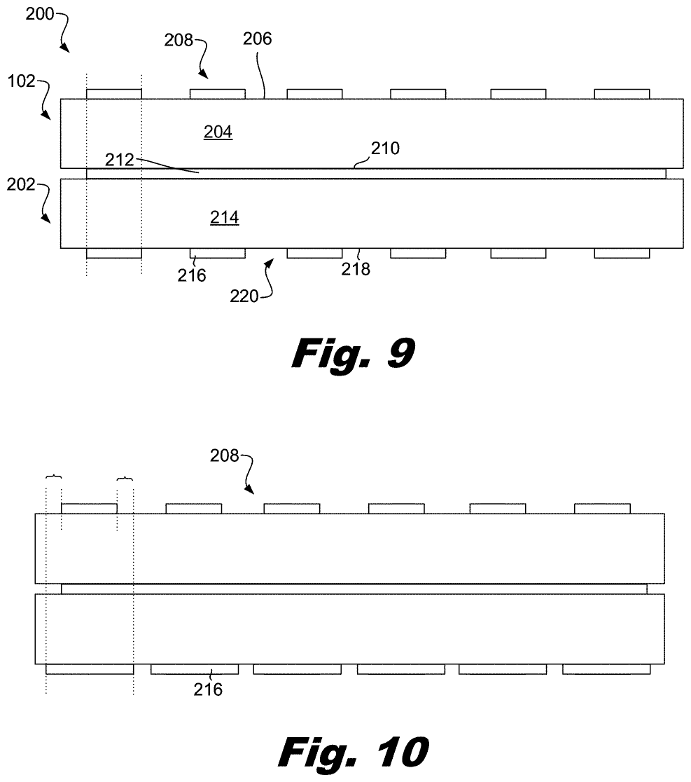

FIG. 9 depicts a cross sectional view of a stack 200 with a touch sensor 102 and a shield structure 202. The touch sensor 102 may include a substrate 204. The substrate 204 may be any appropriate type of substrate, such as a printed circuit board, fiberglass, an electrically insulating material, another type of material, or combinations thereof. On a first side 206 of the substrate 204, a first set 208 of electrodes may be deposited. The first set 208 of electrodes may be transmit electrodes, sense electrodes, or another type of electrodes. On a second side 210 of the substrate 204 opposite of the first side 206, a second set 212 of electrodes may be deposited. The second set 212 of electrodes may be transmit electrodes, sense electrodes, or another type of electrodes. In this example, the first set 208 and the second set 212 of electrodes are orthogonal to each other.

Adjacent to the second set 212 of electrodes may be an electrically insulating material 214, and an electrically conductive material 216 may be deposited on the far side 218 of the electrically insulating material 214, opposite the second set 212 of electrodes.

The electrically conductive material 216 may shield certain portions of the touch sensor 102 from the radio frequencies emitted from an antenna. However, the electrically conductive material 216 may include openings 220 that all the radio frequencies to pass through the shielding material.

In the example of FIG. 9, the width of the electrically conductive material 216 overlapping with the mutual capacitance intersections is as wide as the electrodes in the first set 208. However, in the example of FIG. 10, the width of the electrically conductive material 216 is wider than the width of the electrodes of the first set 208 of electrodes or wider than the mutual capacitance intersection. The width of the electrically conductive material may depend on the tuning and/or other electrically characteristics of the antenna. However, width of the electrically conductive material 216 may also vary throughout the touch sensor based on the proximity to the antenna.

In some examples, it may be desirable to have larger openings in the electrically conductive material in those regions that are closer to the antenna. In such regions, the electrically conductive material 216 may cover less surface area allowing the openings to be larger thereby providing a larger amount of space for the radio frequencies to pass through. In those regions of the touch sensor that are located farther away from the antenna, the openings may be smaller with the electrically conductive material 216 covering a greater amount of the touch sensor's surface area.

FIG. 11 depicts an example of touch sensor 102, a first antenna 300, and a second antenna 302. In this example, the touch sensor 102 has a first region 304, second region 306, and a third region 308. The dashed lines 303 and 305 may generally represent boundary changes between the regions. The first region 304 may be the closest to the antenna 300, 302, the second region 306 may be the next closest to the antennas 300, 302, and the third region 308 may be located the farthest away from the antennas 300, 302. In this example, the openings in the shielding material of the first region 304 may be larger than in the other regions thus the shielding material may cover less overall surface area in the first region 304. In the second region 306, the shielding material may cover an increased amount of surface area making the openings smaller. In the third region 308, the openings may be the smallest allowing the shielding material to cover even more surface area than in the second region 306. In some cases, the shield material in the third region 308 may cover all the surface area without providing openings. The shield material may be the electrically conductive layer described in conjunction with the embodiments in FIGS. 3-10.

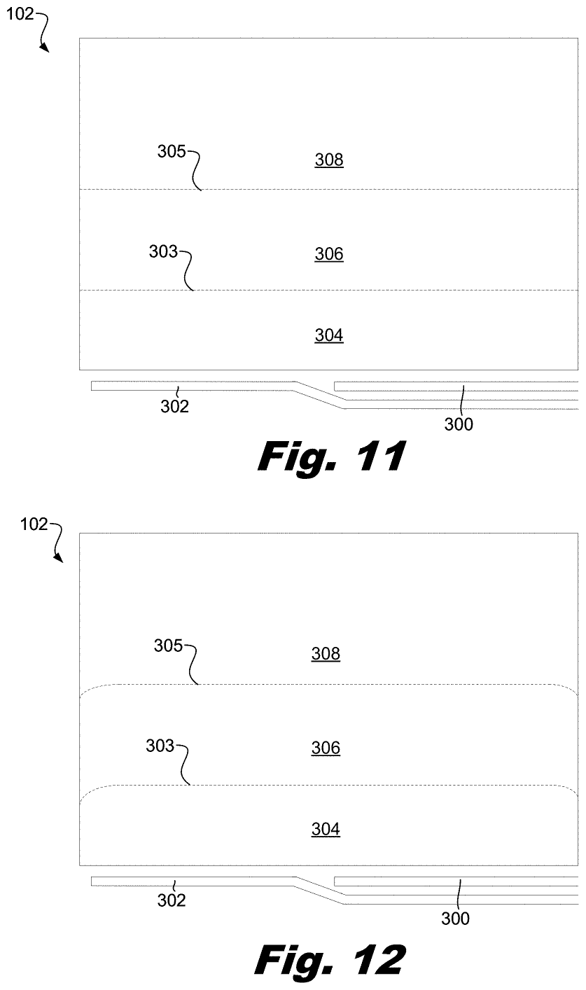

FIG. 12 depicts an example of the boundary changes curving at the edges of the touch sensor 102. In this example, the boundary changes may reside at a predetermined distance from a surface of the antenna or an active portion of the antenna. In this example, the ends of the antennas do not reach the end of the touch sensor 102, thereby allowing the second and third regions 306, 308 of the touch sensor 102 to have greater areas.

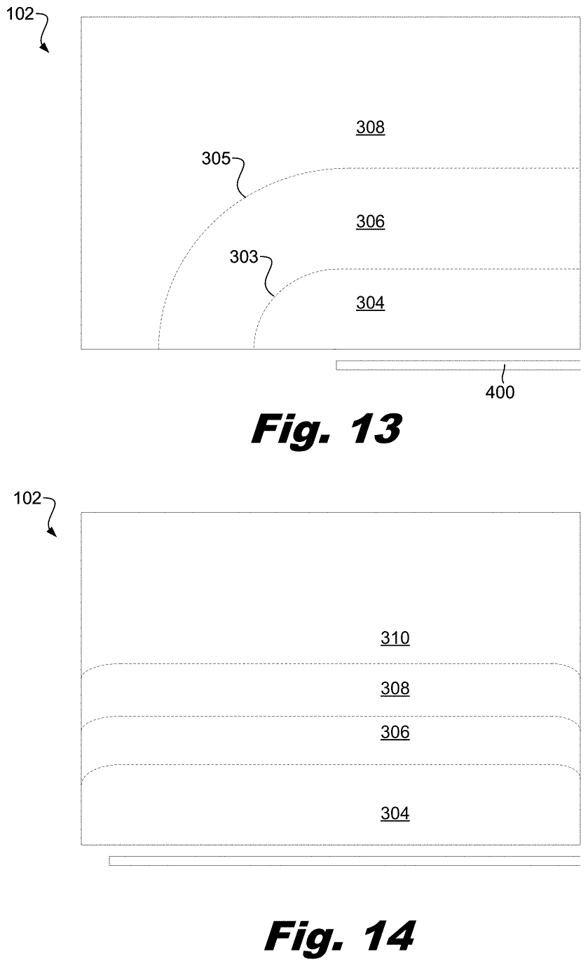

In the example of FIG. 13, just a single antenna 400 is depicted adjacent to the touch sensor 102. In this example, the antenna 400 resides along just a portion of the length of the touch sensor 102. In this example, the boundaries to the first region 304 may decrease while the regions of the second region 306 and third region 308 may increase.

The touch sensor 102 may include any appropriate number of regions with different amounts of shield material. For example, FIG. 14 depicts that the touch sensor 102 may include more than four regions 304, 306, 308, 310, but more regions are included in other embodiments. In some examples, just two regions may exist that have different amounts of shielding.

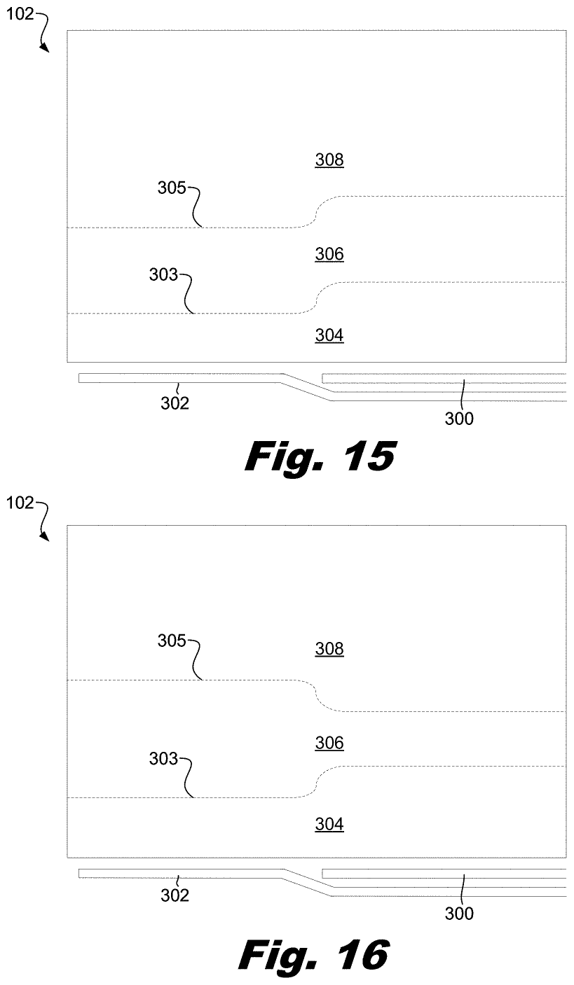

Further, the geometries of those regions with varying amounts of shielding may have different amounts of surface area. In the example of FIG. 15, the boundaries 303, 305 between the regions are irregular. In this example, the boundary regions 303, 305 may be shaped to accommodate the different characteristics of each antenna. For example, it may be desirable for the first region 304 to have more area based on the electrical characteristics of the first antenna 300, while it may be more desirable for the first region 304 to have less area due to the second antenna's electrical characteristics. Thus, the geometry of the different regions may include having less area on one side of the touch sensor 102 than on the other side.

FIG. 16 depicts an example, where the amount of shielding based on the electrical characteristics of the first antenna 300 includes a larger area with less shielding, but transitions more quickly to the second region 306 with more shielding. On the other hand, the electrical characteristics of the second antenna 302 may make it desirable to have a smaller area with less shielding proximate to the second antenna and a longer transition area to the regions with no openings in the shielding. While these examples have depicted touch sensors having specific configurations with varying amounts of shielding, any arrangements of different sizes and geometries of regions with varying amounts of shielding may be used in accordance with the principles described herein.

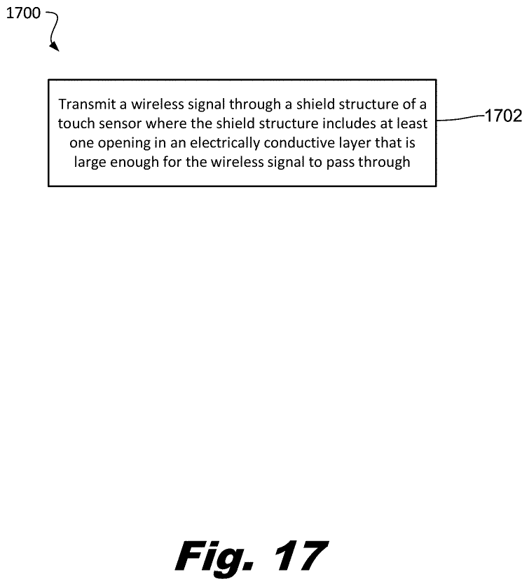

FIG. 17 depicts an example of a method 1700 of transmitting a signal. This method 1700 may be performed based on the description of the devices, module, and principles described in relation to FIGS. 1-16. In this example, the method 17 includes transmitting 1702 a wireless signal through a shield structure of a touch sensor where the shield structure includes at least one opening in an electrically conductive layer that is large enough for the wireless signal to pass through.

In some examples, the wireless signal is a Wi-Fi signal, a Bluetooth signal, a near field communication signal, a wireless signal with another radio frequency, or combinations thereof. The device with the touch pad may be a laptop, a desktop, an external pad for providing input to a computing device or to the cloud computing device, a computing device, a networked device, an electronic tablet, a mobile device, a personal digital assistant, a control panel, a gaming device, a flat panel, a display, a television, another type of device, or combination thereof.

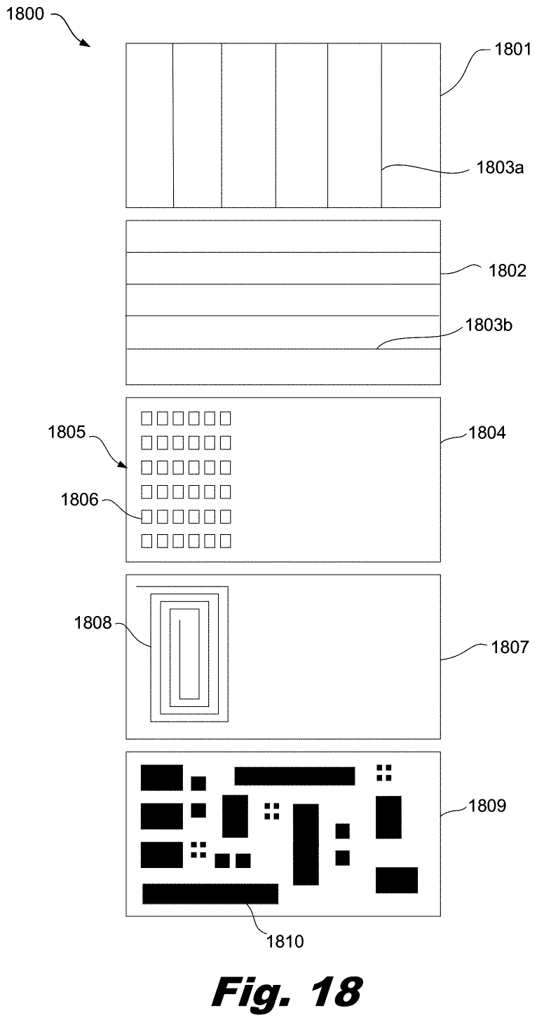

FIG. 18 depicts an example of a stack of layers in accordance with the present disclosure. The stack 1800 includes a first electrode layer 1801, a second electrode layer 1802, a shield layer 1804, an antenna layer 1807, and a component layer 1809. While five layers are identified in this stack, any appropriate number of layers may be used in accordance with the present disclosure. For example, the stacks may include more or fewer layers than depicted. In some examples, the stack may include two layers, four layers, five layers, six layers, another number of layers, or a combination thereof.

The first electrode layer 1801 contains a first set of electrodes 1803a. The first set of electrodes 1803a may be transmit electrodes, sense electrodes, or another type of electrodes. Adjacent to the first electrode layer 1801 is a second electrode layer 1802, which contains a second set of electrodes 1803b. The second set of electrodes 1803b may also be transmit electrodes, sense electrodes, or another type of electrodes. In this example, the first set 1803a and second set 1803b of electrodes cross each other. In this example, together, the first set of electrodes 1803a on the first electrode layer 1801 and the second set of electrodes 1803b on the second electrode layer 1802 form a mutual capacitance sensor.

In the illustrated example, adjacent to the first electrode and second electrode layers 1801, 1802 is a shield layer 1804. The shield layer 1804 is constructed to minimize electrical noise that may interfere with the functioning of the touch sensor. The shield layer 1804 may include copper, aluminum, and/or other appropriate shielding material. The shield material may be etched, printed, or otherwise deposited on a substrate of the shield layer. A radio transparent section 1805 may be defined or formed in the shield layer 1804. The radio transparent section 1805 may include individual subsections 1806 constructed to allow the transmission of an antenna signal to pass through the shield layer 1804. Each individual subsection 1806 may include an opening in the shield material of the shield layer 1804. For example, in cases where the shield is deposited on the shield layer substrate, the shield material may be deposited such that some sections of the substrate are not covered with the shield material. In such an example, the area of the substrate without the shield material may be defined as the radio frequency transparent section. In other examples, another type of material that is transparent to the radio frequency of the antenna may be deposited on the substrate to form the radio transparency section. In yet another example, a through opening may be defined through the thickness of the shield layer 1804 such that the radio frequency may pass through the through opening.

The shield layer 1804 may be between the mutual capacitance sensor formed by the first and second electrode layers 1801, 1802 and an antenna layer 1807. The antenna layer 1807 may include an antenna 1808 printed, etched, deposited, or otherwise formed or added to a substrate of the antenna layer. The antenna layer 1807 may be constructed with materials to broadcast a signal, reduce the resonance of the transmission of the antenna 1808, receive a broadcasted signal, perform another function, or combinations thereof.

While this example depicts an antenna layer 1807 with one antenna 1808, the number of antennas on an antenna layer may be more than one. In some examples, an antenna layer may have two antennas, three antennas, or another appropriate number of antennas.

The antenna 1808 may be used to transmit a single wireless communication protocol. In other examples, the antenna 1808 may be constructed to transmit and/or send signal according to multiple protocols, including but not limited to a Wi-Fi protocol, a short-range wireless protocol, a near field communication (NFC) protocol, Zigbee protocol, another type of protocol, or combinations thereof. In examples where an antenna layer has multiple antennas, each antenna may be used to transmit according to a different protocol.

In some cases, at least one physical characteristic of an antenna 1808 on the antenna layer 1807 may influence the shape and size of the radio transparent section 1805 of the shield layer 1804. For example, the shape, size, orientation, thickness, height, width, length, or another physical parameter of at least one portion of the antenna 1808 may influence the shape and/or size of at least one of the radio frequency transparent sections 1805. The radio transparent section 1805 may be shaped to overlap with the antenna 1808 so that a transmission from the antenna may pass through the radio transparent section 1805 of the shield layer 1804. In some examples, the rest of the shield layer 1804 may be positioned to block electrical signals which may originate from other layers in the stack of layers 1800 and/or other sources that may contribute to electrical interference with the touchpad sensor.

The radio frequency transparent sections 1805 may be positioned so that they block at least some of the more sensitive portions of the mutual capacitance sensor formed by the first 1803a and second 1803b sets of electrodes from the radio frequency from the antenna 1808. For example, radio frequency transparent sections 1805 may be positioned to direct the radio frequency away from the first set 1803a or the second set 1803b of electrodes or the intersections between the first set 1803a and the second set 1803b of electrodes. In some cases, the area between the electrodes of the first set 1803a or second set 1803b of electrodes may be less sensitive to changes in capacitance, and the radio frequency transparent sections 1806 may direct the radio frequency transmissions through the gaps between the electrodes to minimize any potential interference on the electrodes.

In this example, the component layer 1809 is adjacent to the antenna layer 1809. The component layer 1809 may include a printed circuit board. The component layer 1809 may contain individual components 1810 that are used to operate the touchpad. Components may include but are not limited to a central processing unit (CPU), a digital signal processor (DSP), an analog front end (AFE), an amplifier, a peripheral interface controller (PIC), another type of microprocessor, an integrated circuit, a field programmable gate array (FPGA), an application specific integrated circuit (ASIC), a combination of logic gate circuitry, other types of digital or analog electrical components, or combinations thereof.

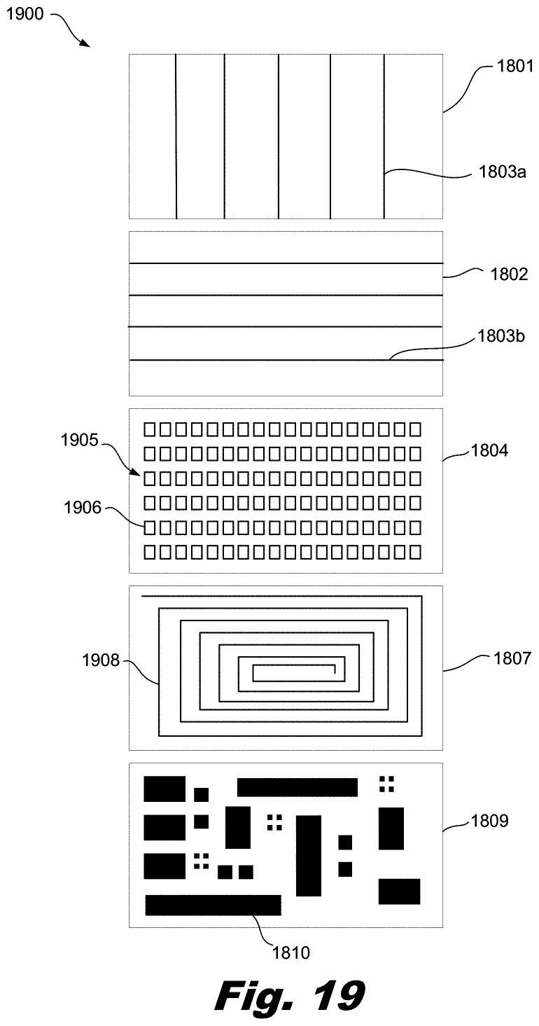

An antenna on an antenna layer and a radio transparent section of a shield layer may be constructed in different sizes and configurations. FIG. 19 is an example of a five-layer stack 1900 where multiple radio transparent sections 1905 made of many radio-transparent subsections 1906 are defined throughout length and width of the shield layer 1804. The size and location of the radio transparent section 1905 may accommodate the antenna's size and pattern. For example, in those cases where the antenna's size occupies substantially all of the antenna layer, the radio frequency transparent sections may be located throughout substantially all of the shield layer. In another example, where the antenna only occupies a first half of the antenna layer, the radio frequency transparent subsections may occupy just the first half of the shield layer where the first half of the antenna layer and the first half of the shield layer align and overlap with each other. In yet another example, in cases where the antenna occupies just a central portion of the antenna layer, the radio frequency transparent subsections may also occupy just a central portion of the shield layer where the radio frequency transparent subsections and the antenna align and overlap with each other.

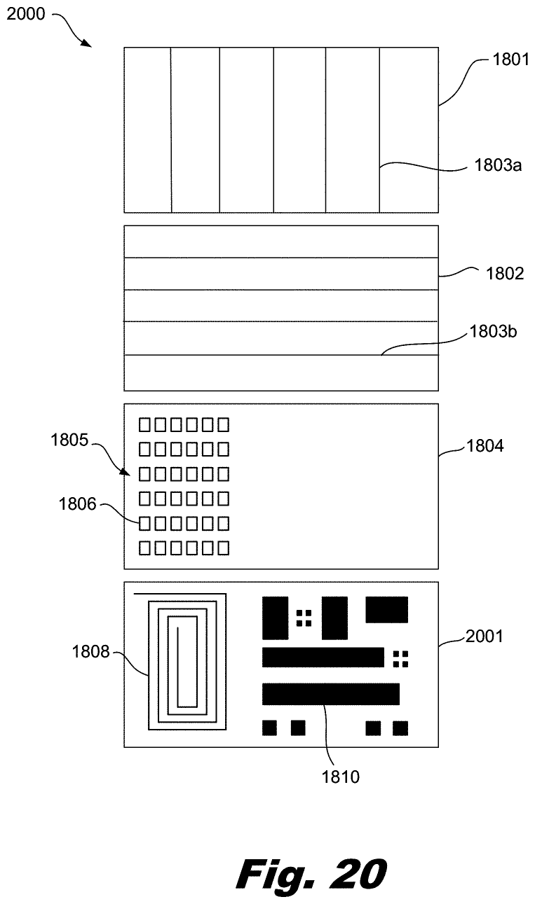

FIG. 20 depicts an example of a four-layer apparatus in accordance with the present disclosure. In this example, a combined antenna-component layer 2001 includes both the antenna 1808 and at least some components 1810 both disposed on the same layer. By placing the antenna and at least some of the components on the same layer the overall thickness of the apparatus may be reduced. In this example, the radio transparent section 1805 of the shield layer 1804 is shaped to overlap with the antenna 1808 only, not the individual components 1810 of the antenna-component layer 2001. In this way, the shield layer 1804 may shield the first electrode layer 1801 and second electrode layer 1802 from electrical interference that may originate from the components 1810 of the antenna-component layer 2001, but still allows a wireless transmission from the antenna 1808 to pass through the shield layer.

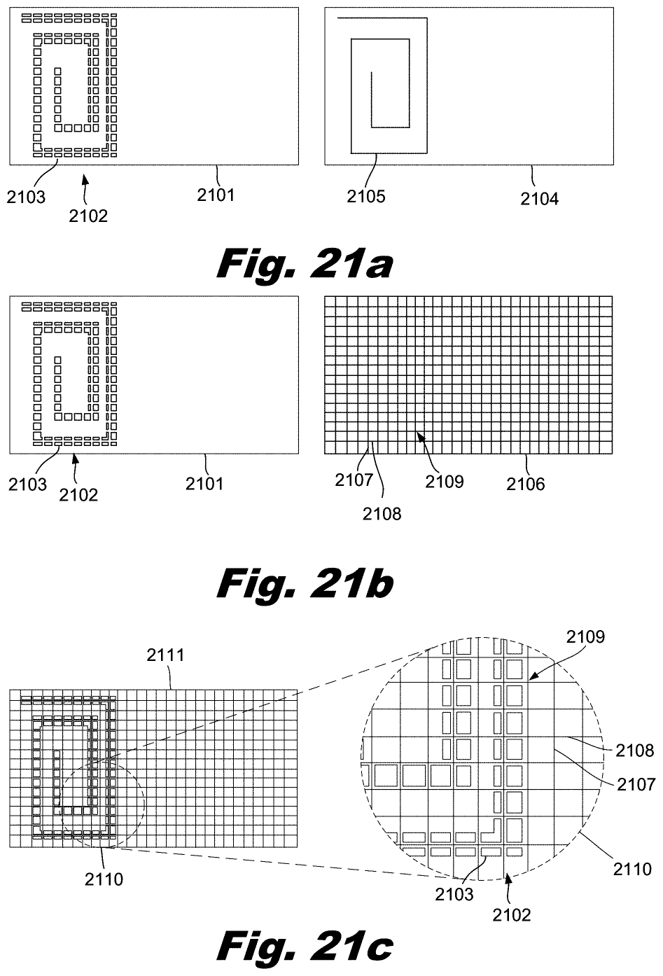

FIG. 21 depicts an example of a shield in accordance with the present disclosure. This example demonstrates how a radio transparent section 2102 on a shield layer 2101 may be shaped to accommodate both the shape of an antenna 2105 and the layout of the electrodes on the sensor layer(s). For illustrative purposes, FIG. 21a shows a shield layer 2101 and an antenna layer 2104 side by side to depict how the radio transparent section 2102 may be shaped with respect to the antenna 2105. In an embodiment, the shield layer 2101 and antenna layer 2104 may be stacked upon each other in the stack of layers 1800. The radio transparent section 2102 is made up of individual subsections 2103 structured to allow the transmission of a wireless signal to pass through the radio transparent section 2102 of the shield layer 2101. The individual subsections 2103 may be openings within the shield layer 2101 or be made of a material that allows the transmission through the shield layer 2101 of a wireless signal to pass through the material. In this example, the antenna 2105 is shaped like a spiral, and the radio transparent section 2102 is also shaped like a spiral to accommodate the antenna.

FIG. 21b depicts the shield layer 2101 and a mutual capacitance sensor 2106. The mutual capacitance sensor 2106 has a first set of electrodes 2107 and a second set of electrodes 2108. In this example, the first set 2107 and second set 2108 of electrodes cross each other at intersections, although in other examples, the two sets of electrodes may be arranged differently. Each intersection 2109 within the mutual capacitance sensor 2106 may be more sensitive to electrical interference than the area between the intersections or even between electrodes. In this case, the individual subsections 2103 of the radio transparent section 2102 may be arranged such that the individual subsections and intersections do not overlap. In this way, each intersection 2109 in the mutual capacitance sensor 2106 may be better shielded by the shield layer 2101 from any electrical interference than the areas of the sensor layers that align with the radio frequency transparent sections.

FIG. 21c depicts the shield layer 2101 with radio transparent section 2102 overlapped with the mutual capacitance sensor 2106. Together, the shield layer 2101 and mutual capacitance sensor 2106 overlap one another. A close-up 2110 of these overlapping layers illustrates that, while the individual subsections 2103 of the radio transparent section 2102 of the shield layer may overlap with electrodes from the first set 2107 and second set 2108 of electrodes, they do not overlap with any intersections 2109 of the mutual capacitance sensor.

In FIG. 21, the individual subsections 2103 of the radio transparent section 2102 are arranged to accommodate a mutual-capacitance touch sensor by being offset from the intersections 2109 of the mutual-capacitance touch sensor while overlapping the antenna 2105. In other examples, individual subsections of a radio transparent section may be arranged to accommodate a self-capacitance touch sensor by being offset from electrodes of a self-capacitance touch sensor altogether.

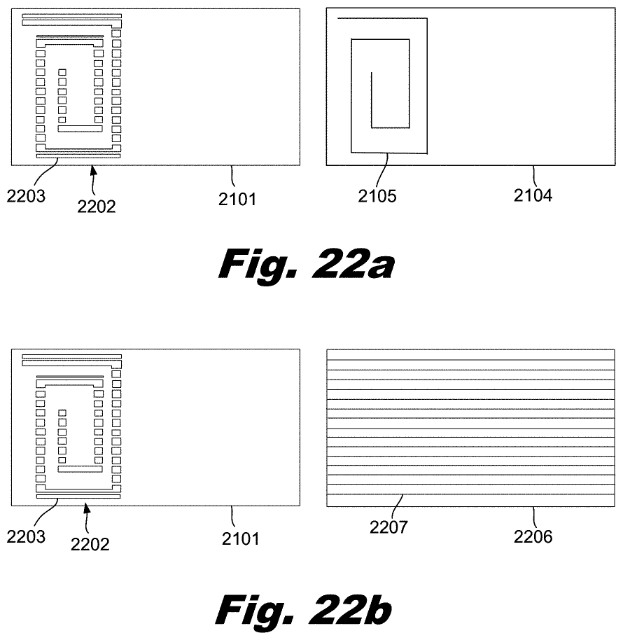

FIG. 22 depicts an example of the shield layer that has a radio transparent section 2202 placed to accommodate the antenna 2105 of the antenna layer 2104 and a set of electrodes 2207 on a self-capacitance sensor 2206.

For illustrative purposes, FIG. 22a depicts the shield layer 2101 side by side with the antenna layer 2104. In this example, the shield layer 2101 has a radio transparent section 2202 that has a spiral shape that overlaps with the spiral shaped antenna 2105 of the antenna layer 2104. The radio transparent section 2202 includes individual subsections 2203. The spiral shape of the radio transparent section 2202 may be help enable a transmission from the antenna 2105 to pass through the radio transparent section 2202 of the shield layer 2101 because the shape of the radio transparent section 2202 matches the shape of the antenna 2105.

FIG. 22b depicts the shield layer 2101 and the self-capacitance sensor 2206. In this example, the self-capacitance sensor 2206 is made of a single set of electrodes 2207. While the set of electrodes 2207 are depicted in a horizontal orientation in this example, they may be arranged in other orientations as well. For example, a set of electrodes may be arranged vertically, diagonally, or in another appropriate orientation. Each electrode within the set of electrodes 2207 may be sensitive to electrical signals, so the individual subsections 2203 of the radio transparent section 2202 of the shield layer 2101 are offset from at least some of the electrodes of the set of electrodes. In this way, the shield layer 2101 may shield the electrode layer 2206 from electrical interference and allow the transmission of a wireless transmission from the antenna 2105 to pass through the shield layer.

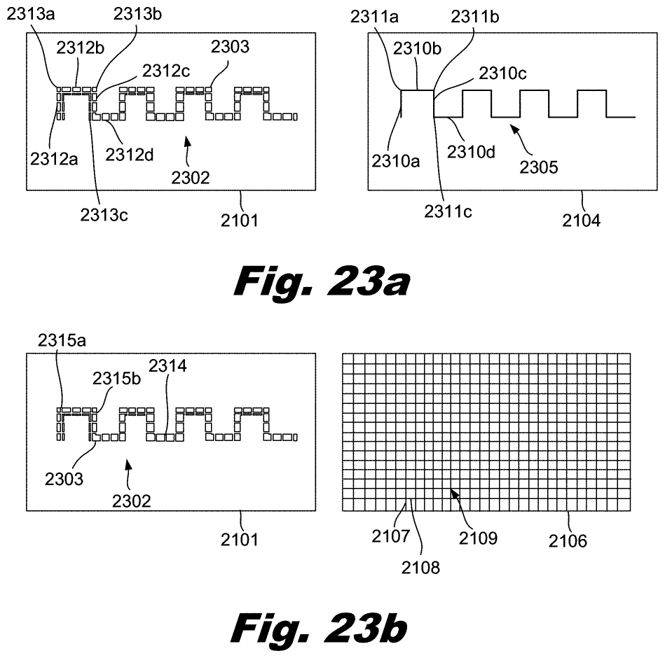

Although FIGS. 21-22 both depict examples with a spiral shaped antenna 2105, examples with different shapes of antennas are possible, as illustrated in FIG. 23. For illustrative purposes, FIG. 23a depicts an example of the shield layer 2101 side by side with an antenna 2305 on the antenna layer 2104. The antenna 2305 has a square wave shape. The square wave antenna 2305 may include a first section 2310a that is transversely oriented and connected to a second section 2310b at a first bend 2311a. A third section 2310c may be transversely oriented to and connected to the second section 2310b at a second bend 2311b. The first section 2310a and the third section 2310c may be aligned with each other. A fourth section 2310d may be connected to and transversely oriented with the third segment 2310c at a third bend 2311c. The second segment 2310b and the fourth segment 2310d may be aligned with each other. This pattern of sections of the square wave antenna 2305 may repeat itself.

The radio transparent section 2302 depicted in the illustrated example may also be shaped like a square wave that is sized to at least a similar size to as the square wave antenna and aligned with the square wave antenna. For example, the radio frequency transparent section may include a first slot 2312a that is transversely oriented to and connected to a second slot 2312b at a first turn 2313a. A third slot 2312c may be transversely oriented to and connected to the second slot 2312b at a second turn 2313b. The first slot 2312a and the third slot 2312c may be aligned with each other. A fourth slot 2312d may be connected to and transversely oriented with the third slot 2312c at a third turn 2313c. The second slot 2312b and the fourth slot 2312d may be aligned with each other. This pattern of slot of the radio frequency transparent section may repeat itself. In some examples, the first section 2310a of the square wave antenna 2305 may align with the first slot 2312a of the radio frequency transparent section. Similarly, the second section 2310b of the square wave antenna may align with the second slot 2312b of the radio frequency transparent section, and so forth.

By placing the square wave antenna 2305 adjacent to and aligned with the radio frequency transparent section 2302 a signal from the antenna may be directed through the radio frequency transparent section. In some examples, just a portion of the antenna is aligned and overlaps with the radio frequency transparent section.

For illustrative purposes, FIG. 23b depicts the shield with radio transparent section 2302 side by side with the mutual capacitance sensor 2106. The individual subsections 2303 of the radio transparent section 2302 are offset from the intersections 2109 of the mutual capacitance sensor 2106. In this way, each intersection 2109 of the mutual capacitance sensor 2106 is adjacent to the material of the shield which shields the shield layer 2101 from the antenna's signal.

The shielding material of the shield layer may form bridges 2314 that define discontinuities in the radio frequency transparent section 2302 and define the subsections 2303 of the radio frequency transparent section. In some cases, the bridges 2314 align with at least one electrode 2106 of the sensor layer(s). In other examples, the bridges 2314 may be formed adjacent to at least one intersection of electrodes in the sensor layer(s). As depicted in FIG. 23b, a first bridge 2315a is formed by the shielding material that is aligned with the length of the shield layer. Also depicted in FIG. 23b is a second bridge 2315b that is aligned with a width of the shield layer. In this example, the first bridge 2315a and the second bridge 2315b are transversely oriented to each other. In other examples, a bridge may be formed to be adjacent to another feature of the sensor layer(s).

In the example of FIG. 23, the radio frequency transparent section 2302 is shaped based at least, in part, on the features in the antenna layer 2104 and in the sensor layer(s) 2106. Features of the antenna layer 2104 that may be used to determine the shape of the radio frequency transparent section 2302 may include a thickness of the antenna 2305, a location of the antenna, a length of the antenna, a width of the antenna, an orientation of the antenna, a bend in the antenna, a number of the antenna on the antenna layer, another feature of the antenna, another feature of the antenna layer, or combinations thereof. Features of the sensor layer(s) 2106 that may be used to determine the shape of the radio frequency transparent section 2302 may include the number of electrodes 2107, 2108, the number of intersections 2109 formed between the electrodes, the thickness of the electrodes, the spacing between the electrodes, the orientation of the electrodes, the location of at least one electrode, other features of the electrodes, other features of the sensor layer(s), or combinations thereof.

In some cases, the radio frequency transparent section 2302 is shaped based at least, in part, on features in the stack of layers 1800 located on a first side of the shield layer 2101 and also based, at least, in part, based on features in the stack of layers located on a second side of the shield layer. In some examples, the radio frequency transparent section 2302 is constructed to permit the passage of signals from a first side of the shield layer 2101 while being constructed to protect electrically sensitive features on the second side of the shield layer.

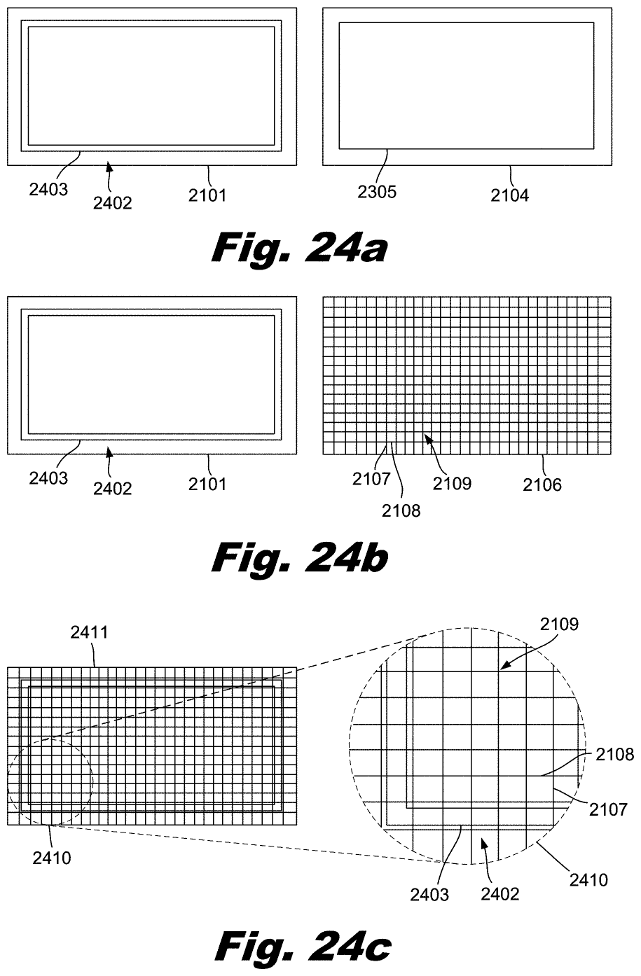

FIG. 24 depicts an example of a shield in accordance with the present disclosure. For illustrative purposes, FIG. 24a shows the shield layer 2101 side by side with the antenna layer 2104. In this example, a square shaped antenna 2305 is on the antenna layer 2104. A radio frequency transparent section 2402 of the shield layer 2101 has a square shape that overlaps with the area of the shield layer that is occupied by the antenna 2305 on the antenna layer 2104. The radio frequency transparent section 2403 includes one individual subsection 2403 which makes up the entire radio frequency transparent section 2402.

FIG. 24b shows the shield layer 2101 side by side with the mutual capacitance sensor 2106. An intersection 2109 is formed between an electrode of the first set of electrodes 2107 and an electrode from the second set of electrodes 2108. The intersections 2109 of the mutual capacitance sensor 2106 may be sensitive to electrical interference. The individual subsection 2403 of the radio frequency transparent section 2402 may be arranged to be offset from at least one or more intersections 2109 in the mutual capacitance sensor 2106.

FIG. 24c shows the shield layer 2101 with radio frequency transparent section 2402 overlapped with the mutual capacitance sensor 2106. A close-up 2410 of the overlapped shield and sensor layers 2411 depicts how the radio frequency transparent section 2402 may overlap with the electrodes from the first set 2107 and second set 2108 of electrodes. In this illustrated example, radio frequency transparent section 2402 is offset from the intersections 2109 of the mutual capacitance sensor. In this case, the shield material of the shield layer is adjacent to the intersections 2109 of the mutual capacitance sensor.

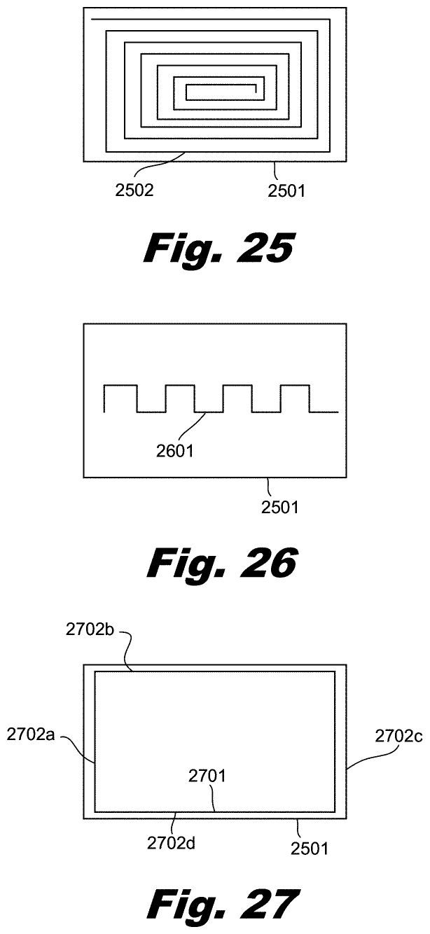

FIG. 25 is an example of an antenna layer in accordance with the present disclosure. An antenna 2502 is depicted on an antenna layer 2501. The antenna 2502 may be etched, printed, or otherwise embodied on the layer's substrate. In this example, the antenna 2502 is spiral shaped, though any appropriate antenna shape suitable for radio frequency transmission may be used. This antenna shape may be used to transmit a wireless signal using the Near Field Communication (NFC) protocol. While this example of the antenna layer 2501 depicts only one antenna 2502, the antenna layer may contain more than one antenna. For example, an antenna layer may contain two antennas, three antennas, or any appropriate number of antennas.

FIG. 26 is an example of an antenna layer in accordance with the present disclosure. A square-wave shaped antenna 2601 is depicted on the antenna layer 2501. The antenna 2601 may be etched, printed, or otherwise embodied on the substrate. This antenna shape may be used to transmit a wireless signal according to a short-range wireless protocol or Wi-Fi protocol.

FIG. 27 is an example of an antenna layer in accordance with the present disclosure. In this example, the antenna is a square shaped antenna 2701 with a first section 2702a, a second section 2702b, a third section 2702c, and a fourth section 2702d. Each of these sections 2702a, 2702b, 2702c, 2702d may be positioned near or on the perimeter of the antenna layer 2501. The antenna 2701 may be etched, printed, or otherwise embodied on the substrate.

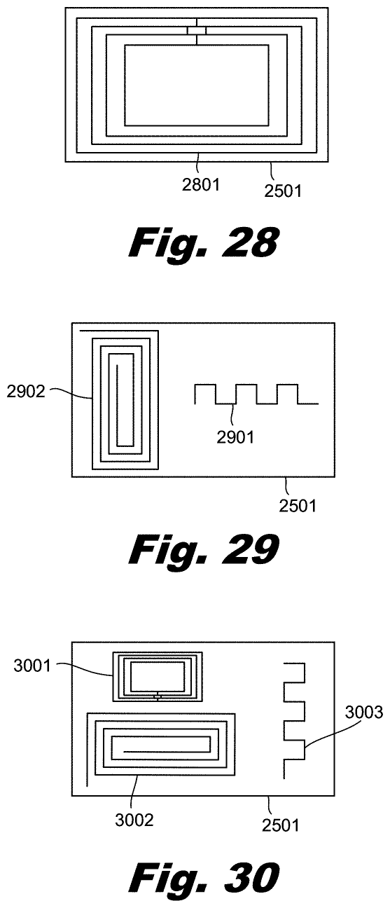

FIG. 28 is an example of an antenna layer in accordance with the present disclosure. An antenna 2801 is pictured on the antenna layer 2501. The antenna 2801 includes four concentric rectangles each connected by one or two traces. The antenna 2801 may be etched, printed, or otherwise embodied on the substrate.

FIG. 29 depicts an example of an antenna layer with two antennas in accordance with the present disclosure. The antenna layer 2501 contains a first antenna 2902 and a second antenna 2901. Both the first and second antenna 2902, 2901 may be etched, printed, or otherwise formed on the layer. The first antenna 2902 may be used to transmit a wireless signal according to a first protocol. The second antenna 2901 may be used to transmit a wireless signal according to another type of protocol.

FIG. 30 depicts an example of an antenna layer with three antennas in accordance with the present disclosure. The antenna layer 2501 contains a first antenna 3001, a second antenna 3002, and a third antenna 3003. The first, second, and third antennas 3001, 3002, 3003 may be etched, printed, or otherwise formed on the layer. The first antenna 3001 may be optimized to transmit a signal at a first protocol, at a first power level, at a first range of frequencies, at a first range of amplitudes, at a first phase, or to operate in a certain way based on another transmission characteristic. The second antenna 3002 may be optimized to transmit a signal on a second protocol that is different from the first protocol, transmit at a second power level that is different than the first power level, transmit at second frequency range that is different than the first frequency range, transmit at a second range of amplitudes that is different than the first amplitude range, or operate in a certain way based on a second characteristic that is different than the first characteristic. The third antenna 3003 may be optimized to operate at yet even different frequencies, amplitudes, protocols, power levels, ranges, or other transmission characteristics.

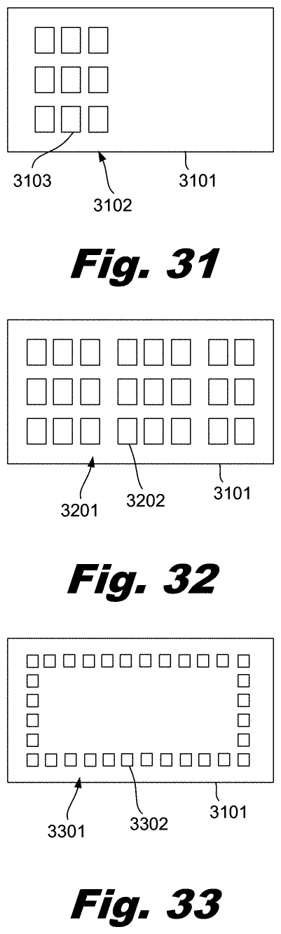

FIG. 31 depicts an example of a shield layer in accordance with the present disclosure. The shape of the radio transparent section 3102 may vary based on the various embodiments of the apparatus. In some cases, the radio transparent section 3102 is shaped to accommodate the shape of an antenna on an antenna layer within the stack of layers. In this example, the radio transparent section 3102 occupies a first portion of the shield layer 3101.

While in this example the shield layer 3101 contains only one radio transparent section 3102, a shield layer may contain multiple distinct radio transparent sections. For example, a shield layer may contain two radio frequency transparent sections, three radio frequency transparent sections, or another appropriate number of radio frequency transparent sections.

FIG. 32 depicts an example of a shield layer in accordance with the present disclosure. In this example, the radio transparent section 3201 extends the width of the shield layer 3101. This example may accommodate a larger antenna on an antenna layer within the stack of layers 1800.

FIG. 33 depicts an example of a shield layer in accordance with the present disclosure. In this example, the radio transparent section 3301 contains individual subsections 3302 that are smaller than the individual subsections 3103, 3202 found on the radio transparent section 3201, 3102. The smaller individual subsections 3302 may be sized to accommodate smaller sized wavelengths that may propagate from an antenna. In this example, the radio transparent section 3301 is also shaped like a square which may overlap with a square shaped antenna near the perimeter of the shield layer 3101. In another example, such a square shaped radio frequency transparent section may accommodate multiple antennas that are placed near the perimeter of the antenna layer.

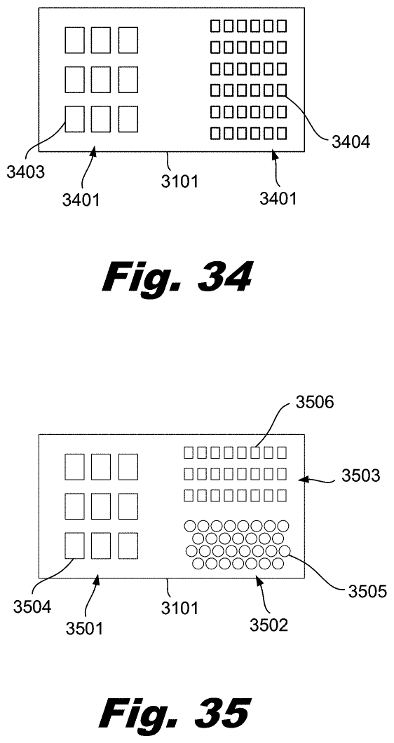

FIG. 34 depicts an example of a shield layer with two radio transparent sections in accordance with the present disclosure. In this example, a first radio and second radio frequency transparent section 3401, 3402 are defined and/or formed on the same shield layer 3101. The first radio transparent section 3401 and second radio transparent section 3402 are shaped to accommodate different antenna configurations, which may be located on an antenna layer within a stack of layers. The first radio transparent section 3401 includes individual subsections 3403 that are larger than the individual subsections 3304 of the second radio transparent section 3401. The differences between the individual subsections 3403 of the first radio transparent section 3401 and the individual subsections 3404 of the second radio transparent section 3404 may accommodate different wavelengths, wave shapes, frequencies, amplitudes, phases, and/or other characteristics of a signal from different antennas.

In some examples, a single antenna layer includes two different antennas. In some cases, the antenna may be of the same kind of antenna. For example, one antenna may be a back-up antenna for the other. In other examples, one or more antennas on the same antenna layer may be optimized to transmit on different protocols, waveforms, frequencies, amplitudes, phases, timings, distances, or other transmission characteristics. In yet another example, the one or more antennas may be located on different antenna layers within the stack of layers.

FIG. 35 depicts an example of a shield layer with three radio frequencies transparent sections in accordance with the present disclosure. In this example, a first radio frequencies transparent section 3501, a second radio frequencies transparent section 3502, and a third radio frequencies transparent section 3503 may be located on the same shield layer 3101. The first, second, and third radio frequencies transparent sections 3501, 3502, 3503 may be shaped to accommodate different types of antennas. The first, second, and third radio frequencies transparent sections 3501, 3502, 3503 each occupy a different space on the shield layer 3101, and each section individual subsections 3504, 3505, and 3506 with different sizes and shapes. These individual subsections 3504, 3505, and 3506 may accommodate different wavelengths or different characteristics of the different antennas.

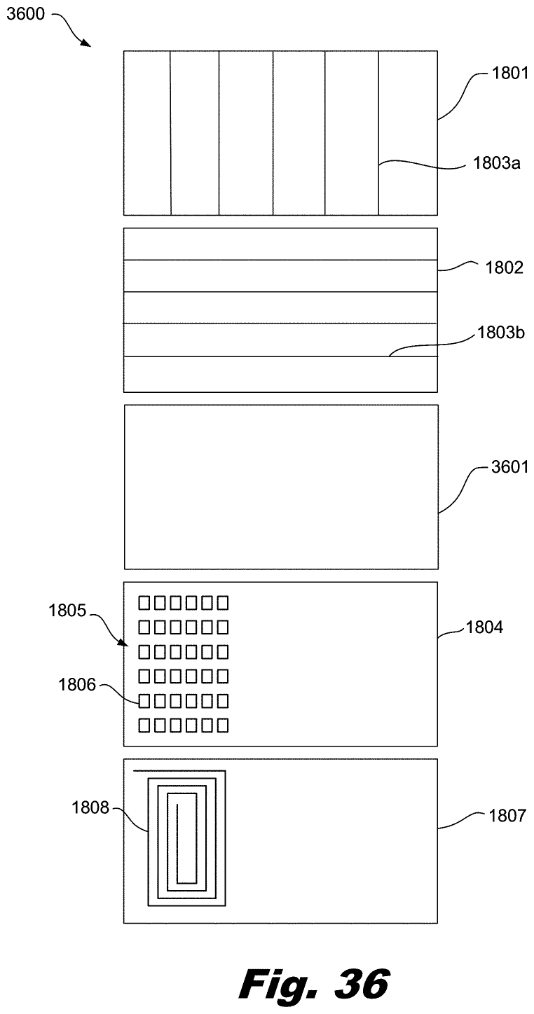

FIG. 36 depicts an example of a stack of layers in accordance with the present disclosure. The stack of layers 3600 in this example includes a pixel layer 3601 between the electrode layer 1802 and the shield layer 1804. The pixel layer 3601 may contain many pixels which may be illuminated by a controller. These illuminated pixels make up a display. In an alternative example, the pixels of the pixel layer are constructed to shield the electrically interfering noise. In such an example, the pixels may be formed on the shield layer. In some examples, at least half of the area of the shield layer is occupied by pixels capable of shielding electrically interfering noise. In other examples, over two-thirds of the shield layer is occupied by the pixels.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. An apparatus, comprising:
a stack of layers, the stack including:
a touch sensor in at least one sensor layer of the stack of layers, the touch sensor having a first set of electrodes and a second set of electrodes, where the first set and the second set are electrically isolated from one another;
an antenna in an antenna layer of the stack of layers; and
a shield located between the at least one sensor layer and the antenna laver.

2. The apparatus of claim 1, wherein the shield includes at least one radio frequency transparent section.

3. The apparatus of claim 2, where the at least one radio frequency transparent section allows radio frequency transmission to pass through the shield and the touch sensor.

4. The apparatus of claim 2, wherein the at least one radio frequency transparent section overlaps with the antenna.

5. The apparatus of claim 1, wherein the antenna layer is combined with a component layer.

6. The apparatus of claim 1, further comprising a component layer between the antenna layer and the shield.

7. The apparatus of claim 1, wherein the antenna is constructed to be compatible to transmit a signal according to a Wi-Fi protocol.

8. The apparatus of claim 1, wherein the antenna is constructed to be compatible to transmit a signal according to a short-range wireless protocol.

9. The apparatus of claim 1, wherein the antenna is constructed to be compatible to transmit a signal according to a Near Field Communication (NFC) protocol.

10. The apparatus of claim 1, wherein the first set of electrodes is formed on a first stack of layers and the second set of electrodes is formed on a second stack of layers.

11. The apparatus of claim 1, wherein the first set of electrodes and the second set of electrodes are formed on the same layer.

12. The apparatus of claim 1, wherein the stack of layers includes a pixel layer adjacent to the at least one sensor layer.

13. The apparatus of claim 1, wherein the first set and second set of electrodes form at least one intersection, and the at least one radio frequency transparent section is offset from the at least one intersection.

14. The apparatus of claim 1, wherein the first set and second set of electrodes form at least one intersection and the at least one radio frequency transparent section overlaps an anti-node formed by the first set of electrodes and the second set of electrodes.

15. An apparatus, comprising:
a stack of layers, the stack including:
a touch sensor layer of the stack of layers;
an antenna layer of the stack of layers; and
a shield layer located between the touch sensor layer and the antenna layer.

16. The apparatus of claim 15, wherein the touch sensor layer is a mutual capacitance sensor.

17. The apparatus of claim 15, wherein the touch sensor layer is a self-capacitance sensor.

18. The apparatus of claim 15, wherein the shield includes at least one radio frequency transparent section.

19. The apparatus of claim 15, wherein the antenna layer is combined with a component layer.

20. An apparatus, comprising:
a shield layer having a first side and a second side, wherein the second side is opposite the first side;
the first side being adjacent to a touch sensor;
the second side being adjacent to an antenna layer;
at least one radio frequency transparent section defined in the shield to minimize electrical interference to the touch sensor based at least, in part, on the location of an electrode in the touch sensor; and
the at least one radio frequency transparent section to permit radio frequency to pass through the touch sensor based at least, in part, on a location and shape of an antenna formed on the antenna layer.
